(19) United States
(12) Patent Application Publication
(10) Pub. No.: US 2024/0185026 A1
(43) Pub. Date: Jun. 6, 2024

(54) DEFECT DETECTION USING MULTI-MODALITY SENSOR DATA

(71) Applicants: NEC Laboratories America, Inc., Princeton, NJ (US); NEC Corporation, Tokyo (JP)

(72) Inventors: LuAn Tang, Cranbury, NJ (US); Yuncong Chen, Plainsboro, NJ (US); Wei Cheng, Princeton Junction, NJ (US); Haifeng Chen, West Windsor, NJ (US); Zhengzhang Chen, Princeton Junction, NJ (US); Yuji Kobayashi, Tokyo (JP)

(21) Appl. No.: 18/493,391

(22) Filed: Oct. 24, 2023

Related U.S. Application Data
(60) Provisional application No. 63/418,996, filed on Oct. 25, 2022.

(51) Int. Cl. G06N 3/0442; G06N 3/08

(52) U.S. Cl. CPC G06N 3/0442; G06N 3/08

(57) ABSTRACT

Methods and systems for defect detection include determining a first residual score by comparing a first predicted system state, determined according to previously measured environment data, to an actual system state. A second residual score is determined by comparing a second predicted system state, determined according to previously measured system state data, to the actual system state. A defect score is generated based on a difference between the first residual score and the second residual score. An automatic action is performed responsive to a determination that the defect score indicates a defect in system behavior.

### RELATED APPLICATION INFORMATION

This application claims priority to U.S. Patent Application No. 63/418,996, filed on Oct. 25, 2022, incorporated herein by reference in its entirety.

### BACKGROUND

### Technical Field

The present invention relates to defect detection and, more particularly, to detection of vehicle system defects using multiple modalities of sensor data.

### Description of the Related Art

Autonomous vehicles, such as self-driving cars, navigate in complicated real-world environments. To do so, they collect information from a variety of sources, internal and external, and attempt to reach their destination quickly, efficiently, and safely.

### SUMMARY

A method for defect detection includes determining a first residual score by comparing a first predicted system state, determined according to previously measured environment data, to an actual system state. Second residual score is determined by comparing a second predicted system state, determined according to previously measured system state data, to the actual system state. A defect score is generated based on a difference between the first residual score and the second residual score. An automatic action is performed responsive to a determination that the defect score indicates a defect in system behavior.

A method for training a model includes determining a first residual score by comparing a first predicted system state, determined by a first model according to environment data from a training dataset, to an actual system state from the training dataset. A second residual score is determined by comparing a second predicted system state, determined by a second model according to system state data from a training dataset, to the actual system state. Parameters of the first model are adjusted to minimize a first objective function based on a difference between the first predicted system state and the actual system state. Parameters of the second model to are adjusted minimize a second objective function based on a difference between the second predicted system state and the actual system state.

A system for defect detection includes a hardware processor and a memory that stores a computer program. When executed by the hardware processor, the computer program causes the hardware processor to determine a first residual score by comparing a first predicted system state, determined according to previously measured environment data, to an actual system state, to determine a second residual score by comparing a second predicted system state, determined according to previously measured system state data, to the actual system state, to generate a defect score based on a difference between the first residual score and the second residual score, and to perform an automatic action responsive to a determination that the defect score indicates a defect in system behavior.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a road scene with an autonomous vehicle that detects defects in its self-driving behavior, in accordance with an embodiment of the present invention;

FIG. 2 is a diagram of an autonomous vehicle that monitors an internal state to help identify defects in its self-driving behavior, in accordance with an embodiment of the present invention;

FIG. 3 is a block diagram of a machine learning model that detects defects in the behavior of a system, in accordance with an embodiment of the present invention;

FIG. 4 is a block/flow diagram of a method for processing environmental data into feature vectors of a predetermined size, in accordance with an embodiment of the present invention;

FIG. 5 is a block/flow diagram of a cross-attention that processes environmental data, in accordance with an embodiment of the present invention;

FIG. 6 is a block/flow diagram of a method for training and using a defect detection model, in accordance with an embodiment of the present invention;

FIG. 7 is a block diagram of a computing device that includes programming code to train and use a defect detection model, in accordance with an embodiment of the present invention;

FIG. 8 is a diagram of an exemplary neural network architecture that can be used as part of the defect detection model, in accordance with an embodiment of the present invention; and

FIG. 9 is a diagram of an exemplary deep neural network architecture that can be used as part of the defect detection model, in accordance with an embodiment of the present invention.

### DETAILED DESCRIPTION OF PREFERRED EMBODIMENTS

Multi-modality data may be collected from multiple different sources and sensors, describing different aspects of a monitored system. The monitored parts of the system may influence one another, resulting in correlations between the different sensor modalities, which can be used to enhance the detection of anomalies within the monitored system. Cross-attention—based anomaly detection can help to find anomalies in multi-modality data.

An example of such anomaly detection can be found in autonomous vehicles, where a defect may be understood as an action performed by the vehicle that is sub-optimal for the circumstances. For example, a car should reduce speed when entering a branching point. If the car does reduce speed in such a circumstance, that is not a defect. If the car does not decelerate, then this may be identified as a defect.

Sensors within a system may be divided into the categories of system data and environment data. System data reflects the operational status of the system. In the context of a vehicle, such system data may include speed measurements, acceleration measurements, braking status, and any other detectable state of the vehicle. The environment data may describe the environment surrounding the system. For example, object detection and lane detection are tasks that may be performed on environment data. In the context of a vehicle, environment data may be collected by sensors such as video cameras or light detection and ranging (LiDAR) cameras. Data may be collected in a regular or irregular time series format.

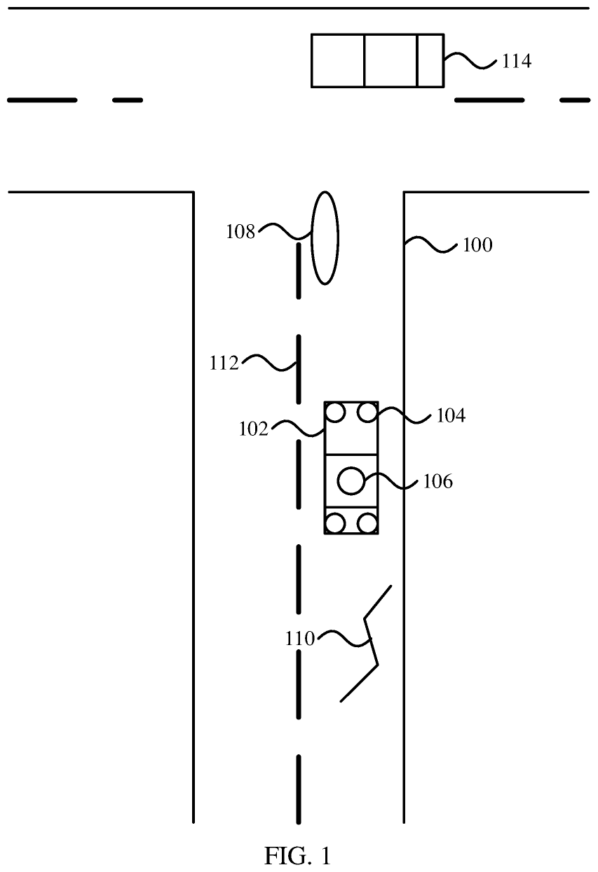

Referring now to FIG. 1, an exemplary road scene is shown. A vehicle 102 operates on a road 100. The vehicle 102 is equipped with sensors that collect information about the road 100. For example, the vehicle 102 may include several video cameras 104, positioned at different locations around the vehicle, to obtain visual information about the road 100 from multiple different perspectives and to provide a wide area of the scene. The vehicle 102 may further include a 360-degree LiDAR sensor 106, positioned to gather geometric information about the road 100 all around the vehicle 102.

The vehicle 102 records information from its sensors. The information may be used to identify flaws in the road 100, which can be used to inform safe operation of the vehicle. The sensors may also collect information relating to other objects in the environment, such as other vehicles 114, structural features such as lamp posts, as well as animals and pedestrians.

Exemplary flaws include potholes 108, ruts, cracks 110, and fading in road markings 112. These flaws may appear on one or both modalities. For example, LiDAR information is sensitive to geometric information and will indicate the shape of the road's surface. This is particularly useful for detecting potholes 108 and cracks 110, but LiDAR sensors 106 may have difficulty identifying defects in the road markings 112. The visual sensors 104, meanwhile, would be well adapted to defects in road markings 112, but may miss potholes 108 and cracks 110 in adverse lighting conditions. Additionally, when used in combination, the different modalities reinforce one another and provide superior results even in cases where each would independently be able to recognize the road flaw.

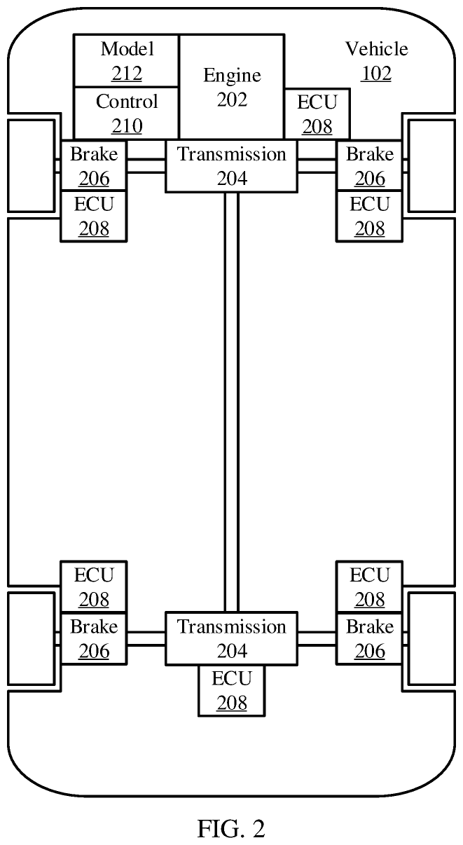

Referring now to FIG. 2, additional detail on a vehicle 102 is shown. A number of different sub-systems of the vehicle 102 are shown, including an engine 202, a transmission 204, and brakes 206. It should be understood that these sub-systems are provided for the sake of illustration, and should not be interpreted as limiting. Additional sub-systems may include user-facing systems, such as climate control, user interface, steering control, and braking control. Additional sub-systems may include systems that the user does not directly interact with, such as tire pressure monitoring, location sensing, collision detection and avoidance, and self-driving.

Each sub-system is monitored by one or more electronic control units (ECUs) 208, which perform measurements of the state of the respective sub-system. For example, ECUs 208 relating to the brakes 206 may determine an amount of pressure that is applied by the brakes 206, temperature of the brakes 206, and remaining usable lifetime of the brakes 206. The information that is gathered by the ECUs 208 is supplied to the controller 210. ECUs 208 related to the engine 202 may identify acceleration and revolutions per minute (RPMs).

Communications between ECUs 208 and the sub-systems of the vehicle 102 may be conveyed by any appropriate wired or wireless communications medium and protocol. For example, a car area network (CAN) may be used for communication. The time series information may be communicated from the ECUs 208 to the controller 210, and instructions from the controller 210 may be communicated to the respective sub-systems of the vehicle 102.

The controller 210 uses the defect detection model 212 to determine whether the time series information from the ECUs 208 indicates a defect. The new time series information is input to the model 212, and the model 212 outputs a label (e.g., “normal” or “defect”) that may include an indication of a sub-system that is responsible for a defect condition. The model 212 may further make use of information about the environment of the vehicle 102 based on information from environmental sensors.

The controller 210 may communicate internally, to the sub-systems of the vehicle 102 and the ECUs 208, as well as externally, to a model training system. For example, the controller 210 may receive model updates from the model training system, and may furthermore provide collected time series information from the ECUs 208 back to the model training system. For example, in the event that the model 212 indicates abnormal behavior, the controller 210 may send the corresponding time series information back to the model training system, where it may be used to train future iterations of the model 212.

The model 212 integrates data from different modalities and makes determinations based on changes in the received sensor information. In particular, an attention may be defined as the measurement for the environment changes. Cross-attention applies the influences of the environment changes to the vehicle's system data to construct a model that records normal reactions of the vehicle 102 in different environments. During operation, the model 212 determines the current environment of the vehicle 102 and performs defect detection on system data. The model 212 can adapt to dynamic environments to provide highly accurate defect detection in complex scenarios.

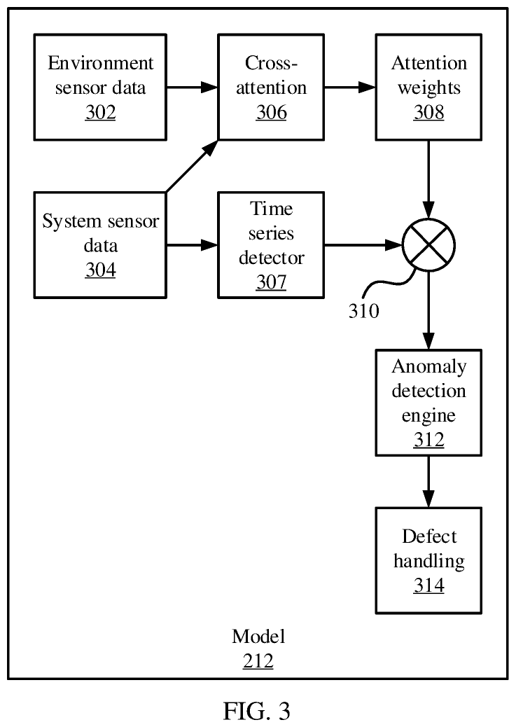

Referring now to FIG. 3, additional detail on model 212 is shown. The model accepts inputs that include environment sensor data 302 and system sensor data 304. The environment sensor data 302 and the system sensor date 304 are both processed by a cross-attention network 306, which generates attention weights 308. The system sensor data is processed by a separate time series detector 307. The attention weights 308 are combined with the output of the time series detection 307 at combiner 310 and are used as inputs to anomaly detection engine 312. The anomaly detection engine 312 outputs corresponding defect information, for example identifying normal (non-defective) behavior, a known defect, or an unknown defect. Defect handling 314 identifies how to handle the defect, for example issuing instructions to control 210 to guide future behavior of the vehicle 102.

The environment sensor data 302 may reflect changes to the measured environment. For example, if external sensors on the vehicle 102 detects an obstacle in the vehicle's path, the control 210 prompts an appropriate action responsive to the changed environment. During normal, defect-free operation, the control 210 may perform lane change to avoid the obstacle. In a defect case, the control 210 may not perform the correct action, for example performing a lane change when there is no obstacle in the way, or performing a lane change that moves the vehicle 102 into a forbidden area. The present model 212 makes it possible to detect such defects by considering the status of the environment jointly with the system state.

The external sensors of the vehicle 102 generate the external sensor data 302. One example of such sensors is LiDAR 106, which detects surrounding objects and lanes by the reflection of laser emissions. The LiDAR sensor 106 may generate data in the format of a sequence of detected objects, for example by processing raw sensor data with an object detection task. Attributes of detected objects may include location, speed, size, acceleration, etc. However, because objects are detected as the vehicle 102 encounters them, the timing of such external sensor information may be aperiodic. For example, there may be twenty objects around the vehicle 102 at a first timestamp, but thirty objects around the vehicle 102 at a second timestamp.

The output of the cross-attention—based detector 306 may include a first residual score. The time series detector 307 may include a long-short term memory (LSTM) neural network that may output a second residual score. Combiner 310 combines these two scores to generate the final defect score. The first and second residual scores may represent differences between a prediction and real values of the system data. The cross-attention— based detector 306 and the time series detector 307 may be trained using data collected during normal operation of the system, and parameters of the respective detectors may be updated during training to minimize the residual scores. During operation, the residual scores may be compared to a threshold, with above-threshold scores being identified as anomalies. Such anomalies may or may not identify defects, and the score integrator may determine a defect score based on comparison of both residual scores.

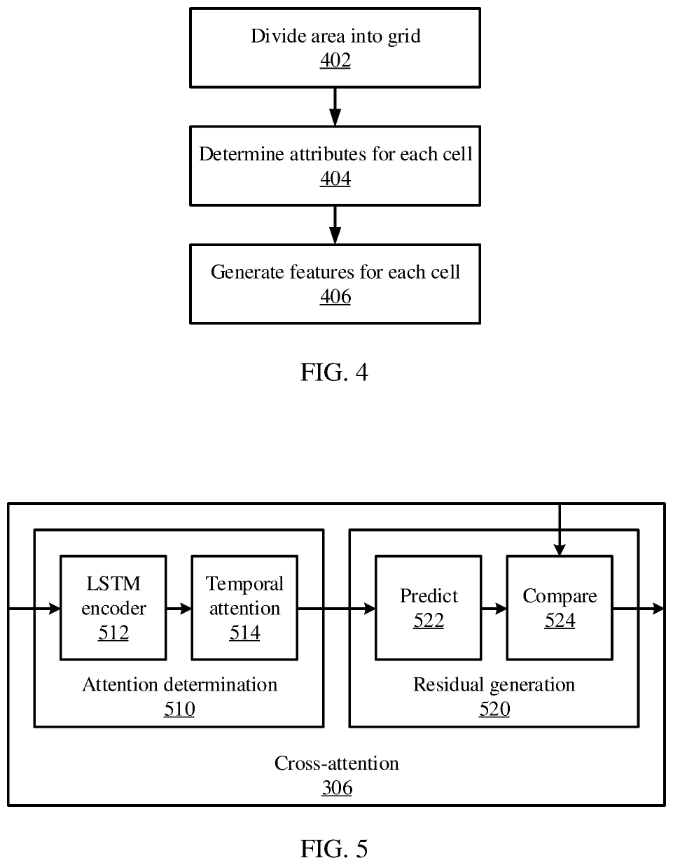

Referring now to FIG. 4, a method of generating fixed numbers of features from dynamically changing object detection data is shown. A grid-based feature retrieval may be used. Block 402 divides the area around the vehicle 102 into a grid of nine spatial regions, with a middle region being occupied by the vehicle 102 itself. Each cell of the grid may have a predefined length and width. The detected objects located inside the cells may be considered, while objects detected as being outside the grid are distant from the vehicle 102 and may be ignored. Although a grid of rectangular regions is specifically contemplated, it should be understood that alternative grid shapes may be used instead, such as hexagons.

Block 404 retrieves the spatial attributes of objects for each cell within the grid, for example including number of objects, nearest object size, nearest object distance, nearest object speed, etc. Block 406 then generates features for each cell based on the retrieved attributes. In this manner a consistent number of features can be determined from the environment sensor data 302, regardless of how many objects are detected therein.

Referring now to FIG. 5, additional detail on the cross-attention 306 is shown. An attention determination unit 510 takes as input environment data X, for example made up of features generated from external sensors. The environment data is encoded by an LSTM encoder 512 to generate keys h₁, h₂, . . . hₜ₋₁. The environment data at a timestamp t may be used as a query to temporal attention 514. The query is matched to the keys by temporal attention 514 to generate attention weights a₁, . . . , aₜ₋₁.

Residual generation 520 accepts the attention weights and system data y as inputs. The weights are used to multiply respective elements y₁, . . . , yₜ₋₁ of the system data y to predict the value of the system at the time t, expressed as yₜ′ in prediction block 522. The differences between yₜ and yₜ′ are measured in comparison 524 to generate the first residual score.

During training, the parameters of the LSTM encoder 512, the temporal attention unit 514, and the prediction 522 to minimize a loss function (yₜ−yₜ′)², where yₜ is a known value of the system sensor data from the training dataset and where yₜ′ is the predicted value.

The time series detector 307 operates in a manner similar to that of residual generation 520, without the use of attention information. In that case, a prediction yₜ″ is generated for the system sensor data, for example using an LSTM network, and this prediction is compared to the actual system data for the corresponding time yₜ. As above, the time series detector 307 may be trained using a loss function (yₜ−yₜ″)² and the second residual score may be determined during operation as the difference between yₜ and yₜ″.

Combiner 310 combines the first residual score and the second residual score to generate a final defect score. The defect score may be determined as the greater of zero and the second residual score subtracted from the first residual score. Thus, if the first residual score is score₁ and the second residual score is score₂, then the defect score is:

defect=max(0,score₁−score₂)

If the first residual score is smaller than the second residual score (thus, score₁−score₂<0), then the changes seen in the system data are adaptive to changes in the environmental data. Thus the system has conducted appropriate reactions to environmental changes and there is no defect, generating a defect score of zero.

If the first residual score is larger than the second residual score (thus, score₁−score₂>0), then the changes in system data are not appropriate to the environmental changes, or may even be opposite to those called for by the environment. In such a case, the system has performed an action that is not appropriate to the environment, and the defect may be reported.

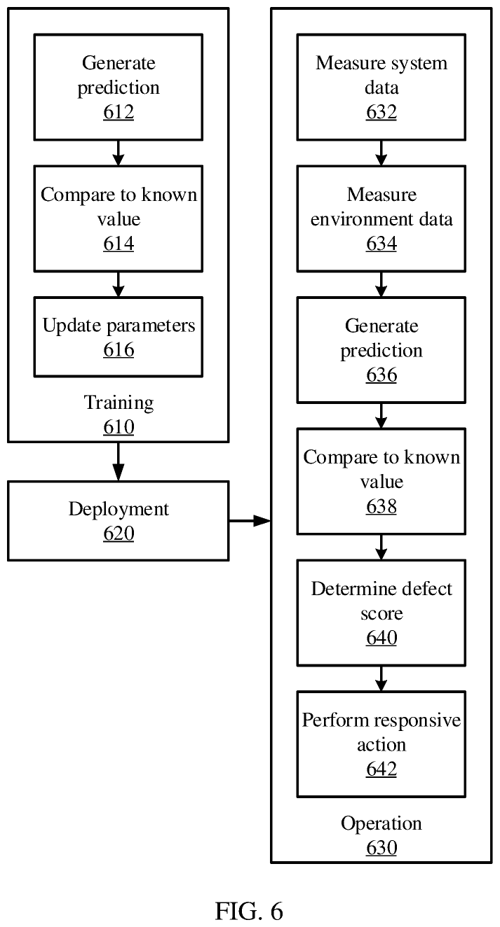

Referring now to FIG. 6, a method of training and using a defect detection system is shown. Three steps are shown, including training 610, deployment 620, and operation 630. Training 610 trains a defect detection model as described above, deployment 620 installs the model in a target system, such as vehicle 102, and operation 630 makes use of current sensor data to detect defects in the operation of the target system.

Training 610 makes use of a set of training data, including environment sensor data 302 and system sensor data 304. The cross-attention 306 and time series detector 307 are used to determine residual scores by forming predictions in block 612 and comparing the predictions to known-normal operation information from the training data in block 614. The parameters of the cross-attention 306 and time series detector 307 may be updated based on differences between the predicted state and the known-normal state.

Deployment 620 copies the completed model 212 to the target system, for example by installing a defect detection system in an autonomously controlled vehicle 102. Deployment 620 may further include any appropriate adaptation of the trained model 212 to the target system, for example using system-specific training data to update parameters of the model in a local fine-tuning.

During operation 630, new sensor data is collected from the target system, including system sensor data in block 632 and environment sensor data in block 634. This sensor data is collected from respective sensors, and may be converted to a form appropriate for use with the model 212 as described above. Block 636 generates a prediction of the system state using the model 212 as described above, and block 638 compares the prediction to the actual system state. Based on the residual scores described above, block 640 determines a defect score.

Block 642 performs an action responsive to the defect score. This may include comparing the defect score to a threshold and determining, for defect scores above the threshold, that a defect has occurred. When such a defect occurs, the system may perform an action to correct the defect and/or to prevent future defects. In some cases, the system may respond by disabling autonomous control and alerting a human operator take over operation of the vehicle. This may ensure safety in circumstances where the autonomous driving system is malfunctioning. In other cases, the system may respond by automatically performing a corrective action that corrects the defect. For example, if the vehicle was found to have accelerated in a circumstance where it should have applied its brakes, the corrective action may include deceleration and an adjustment to steering to achieve a more appropriate speed and heading. In another example of a corrective action, where a defective action was found to bring the vehicle closer to a road hazard, the corrective action may be to automatically steer the vehicle away from the road hazard, accommodating for any deviations from an optimal path. Thus, responsive actions may include disabling an autonomous driving function of the vehicle, compensating for an earlier defect, and/or avoiding a hazard that was created by an earlier defect.

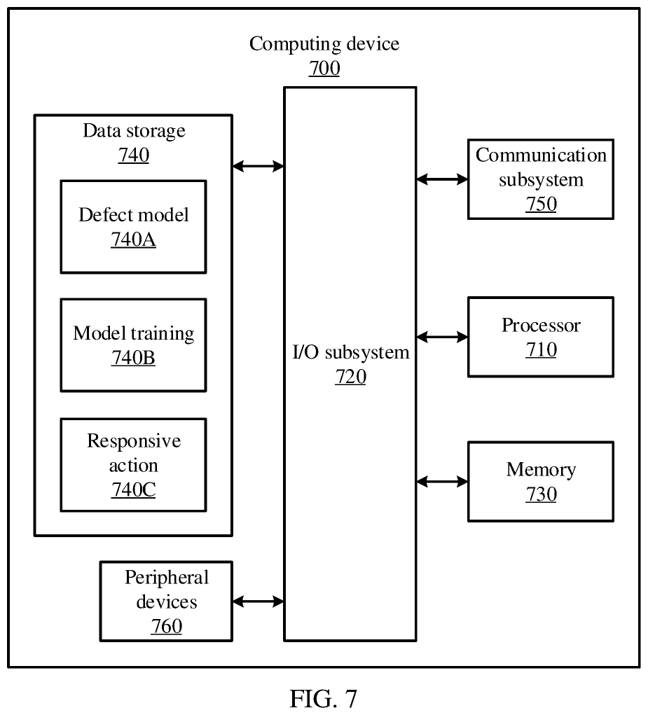

Referring now to FIG. 7, an exemplary computing device 700 is shown, in accordance with an embodiment of the present invention. The computing device 700 is configured to perform defect detection.

The computing device 700 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 700 may be embodied as one or more compute sleds, memory sleds, or other racks, sleds, computing chassis, or other components of a physically disaggregated computing device.

As shown in FIG. 7, the computing device 700 illustratively includes the processor 710, an input/output subsystem 720, a memory 730, a data storage device 740, and a communication subsystem 750, and/or other components and devices commonly found in a server or similar computing device. The computing device 700 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 730, or portions thereof, may be incorporated in the processor 710 in some embodiments.

The processor 710 may be embodied as any type of processor capable of performing the functions described herein. The processor 710 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 730 may be embodied as any type of volatile or non-volatile memory or data storage capable of performing the functions described herein. In operation, the memory 730 may store various data and software used during operation of the computing device 700, such as operating systems, applications, programs, libraries, and drivers. The memory 730 is communicatively coupled to the processor 710 via the I/O subsystem 720, which may be embodied as circuitry and/or components to facilitate input/output operations with the processor 710, the memory 730, and other components of the computing device 700. For example, the I/O subsystem 720 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 720 may form a portion of a system-on-a-chip (SOC) and be incorporated, along with the processor 710, the memory 730, and other components of the computing device 700, on a single integrated circuit chip.

The data storage device 740 may be embodied as any type of device or devices configured for short-term or long-term storage of data such as, for example, memory devices and circuits, memory cards, hard disk drives, solid state drives, or other data storage devices. The data storage device 740 can store program code 740A for a defect detection model, 740B for training the defect detection model, and/or 740C for performing an action responsive to detected defects. Any or all of these program code blocks may be included in a given computing system. The communication subsystem 750 of the computing device 700 may be embodied as any network interface controller or other communication circuit, device, or collection thereof, capable of enabling communications between the computing device 700 and other remote devices over a network. The communication subsystem 750 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 700 may also include one or more peripheral devices 760. The peripheral devices 760 may include any number of additional input/output devices, interface devices, and/or other peripheral devices. For example, in some embodiments, the peripheral devices 760 may include a display, touch screen, graphics circuitry, keyboard, mouse, speaker system, microphone, network interface, and/or other input/output devices, interface devices, and/or peripheral devices.

Of course, the computing device 700 may also include other elements (not shown), as readily contemplated by one of skill in the art, as well as omit certain elements. For example, various other sensors, input devices, and/or output devices can be included in computing device 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

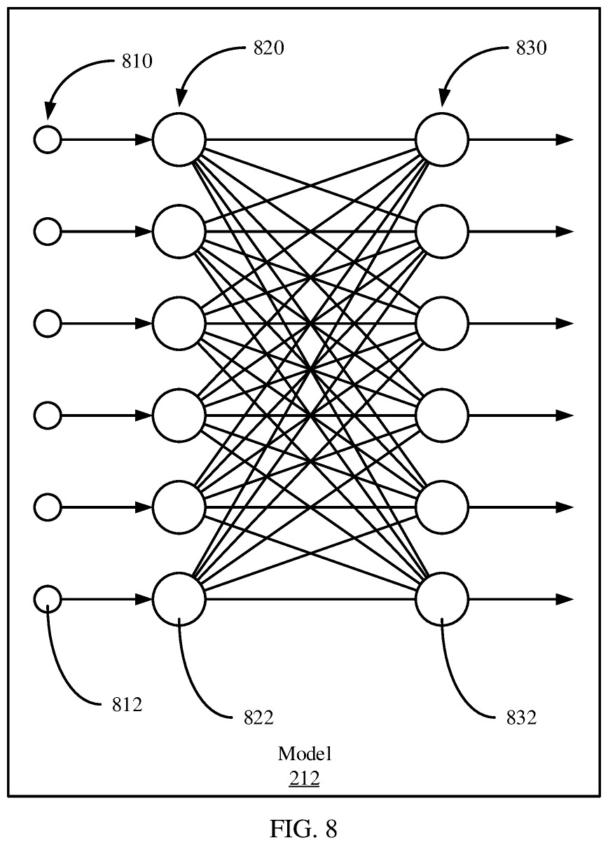

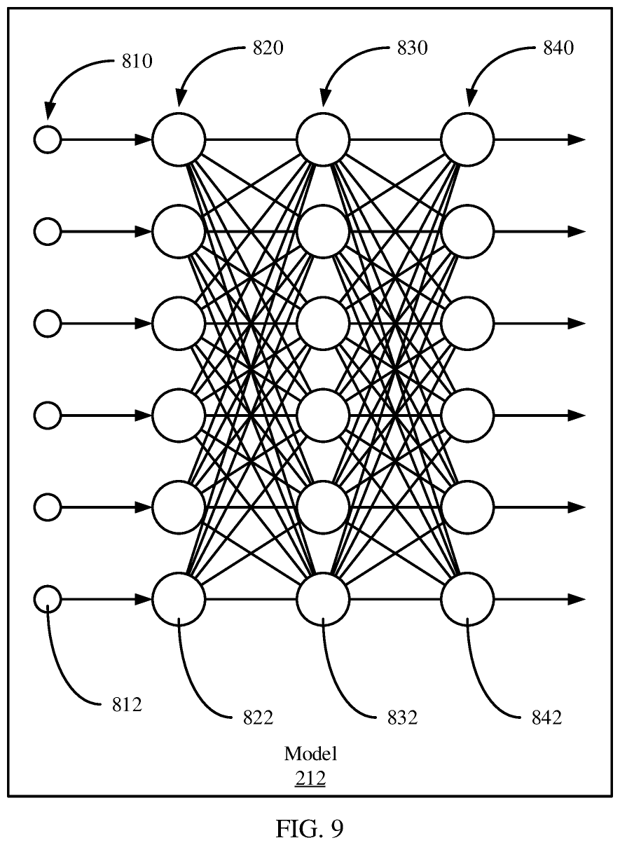

Referring now to FIGS. 8 and 9, exemplary neural network architectures are shown, which may be used to implement parts of the present models, such as the defect detection model 212. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 820 of source nodes 822, and a single computation layer 830 having one or more computation nodes 832 that also act as output nodes, where there is a single computation node 832 for each possible category into which the input example could be classified. An input layer 820 can have a number of source nodes 822 equal to the number of data values 812 in the input data 810. The data values 812 in the input data 810 can be represented as a column vector. Each computation node 832 in the computation layer 830 generates a linear combination of weighted values from the input data 810 fed into input nodes 820, and applies a non-linear activation function that is differentiable to the sum. The exemplary simple neural network can perform classification on linearly separable examples (e.g., patterns).

A deep neural network, such as a multilayer perceptron, can have an input layer 820 of source nodes 822, one or more computation layer(s) 830 having one or more computation nodes 832, and an output layer 840, where there is a single output node 842 for each possible category into which the input example could be classified. An input layer 820 can have a number of source nodes 822 equal to the number of data values 812 in the input data 810. The computation nodes 832 in the computation layer(s) 830 can also be referred to as hidden layers, because they are between the source nodes 822 and output node(s) 842 and are not directly observed. Each node 832, 842 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁. wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 832 in the one or more computation (hidden) layer(s) 830 perform a nonlinear transformation on the input data 812 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for defect detection, comprising:
determining a first residual score by comparing a first predicted system state, determined according to previously measured environment data, to an actual system state;
determining a second residual score by comparing a second predicted system state, determined according to previously measured system state data, to the actual system state;
generating a defect score based on a difference between the first residual score and the second residual score; and
performing an automatic action responsive to a determination that the defect score indicates a defect in system behavior.

2. The method of claim 1, wherein determining the first residual score includes processing the previously measured environment data with a temporal attention and comparing a prediction based on the temporal attention to the previously measured system state data.

3. The method of claim 1, wherein processing the previously measured environment data includes generating a set of weights, further comprising generating the prediction by multiplying the previously measured system state data by the set of weights.

4. The method of claim 1, wherein determining the second residual score includes processing the previously measured system state data with a time series detector with a long-short term memory model.

5. The method of claim 1, wherein generating the defect score includes subtracting the second residual score from the first residual score to compute a difference.

6. The method of claim 5, wherein the defect score is the greater of the difference and zero.

7. The method of claim 1, further comprising converting information about detected objects in the previously measured environment data to feature vectors of predetermined length.

8. The method of claim 1, wherein performing the automatic action includes an action selected from the group consisting of disabling an autonomous driving function of the system, performing an autonomous action to compensate for an earlier defect, and performing an autonomous action to avoid a hazard that an earlier defect created.

9. A computer-implemented method for training a model, comprising:
determining a first residual score by comparing a first predicted system state, determined by a first model according to environment data from a training dataset, to an actual system state from the training dataset;
determining a second residual score by comparing a second predicted system state, determined by a second model according to system state data from a training dataset, to the actual system state;
adjusting parameters of the first model to minimize a first objective function based on a difference between the first predicted system state and the actual system state; and
adjusting parameters of the second model to minimize a second objective function based on a difference between the second predicted system state and the actual system state.

10. The method of claim 9, wherein determining the first residual score includes processing the environment data from the training dataset with a temporal attention and comparing a prediction based on the temporal attention to the system state data from the training dataset.

11. The method of claim 9, wherein processing the environment data from the training dataset includes generating a set of weights, further comprising generating the prediction by multiplying the system state data from the training dataset by the set of weights.

12. The method of claim 9, wherein determining the second residual score includes processing the system state data from the training dataset with a time series detector with a long-short term memory model.

13. A system for defect detection, comprising:
a hardware processor; and
a memory that stores a computer program which, when executed by the hardware processor, causes the hardware processor to:
determine a first residual score by comparing a first predicted system state, determined according to previously measured environment data, to an actual system state;
determine a second residual score by comparing a second predicted system state, determined according to previously measured system state data, to the actual system state;
generate a defect score based on a difference between the first residual score and the second residual score; and
perform an automatic action responsive to a determination that the defect score indicates a defect in system behavior.

14. The system of claim 13, wherein the computer program further causes the hardware processor to process the previously measured environment data with a temporal attention and to compare a prediction based on the temporal attention to the previously measured system state data.

15. The system of claim 13, wherein the computer program further causes the hardware processor to generate set of weights to process the previously measured environment data and to generate the prediction by multiplying the previously measured system state data by the set of weights.

16. The system of claim 13, wherein the computer program further causes the hardware processor to process the previously measured system state data with a time series detector with a long-short term memory model.

17. The system of claim 13, wherein the computer program further causes the hardware processor to subtract the second residual score from the first residual score to compute a difference.

18. The system of claim 17, wherein the defect score is the greater of the difference and zero.

19. The system of claim 17, wherein the computer program further causes the hardware processor to convert information about detected objects in the previously measured environment data to feature vectors of predetermined length.

20. The system of claim 13, wherein the computer program further causes the hardware processor to select the automatic action from the group consisting of disabling an autonomous driving function of the system, performing an autonomous action to compensate for an earlier defect, and performing an autonomous action to avoid a hazard that an earlier defect created.
